(19) United States
(12) Patent Application Publication
(10) Pub. No.: US 2021/0358260 A1
(43) Pub. Date: Nov. 18, 2021

(54) CASINO GAMING MACHINES CONFIGURED TO RESIST VIRUSES, BACTERIA AND FUNGI AND THAT ARE CONFIGURED TO CURB THE SPREAD OF INFECTIOUS DISEASES

(71) Applicant: SYNERGY BLUE, LLC, Las Vegas, NV (US)

(72) Inventors: Georg M. WASHINGTON, Las Vegas, NV (US); Harry INGLETT, Henderson, NV (US); Brian DOLAN, Las Vegas, NV (US)

(21) Appl. No.: 17/306,225

(22) Filed: May 3, 2021

Related U.S. Application Data
(60) Provisional application No. 63/026,693, filed on May 18, 2020.

(51) Int. Cl. G07F 17/32; A01N 59/16; A01N 59/20; A01N 59/06

(52) U.S. Cl. CPC G07F 17/3204; A01N 59/06; A01N 59/20; A01N 59/16

(57) ABSTRACT

Gaming machines cabinets are disclosed that are designed and constructed to resist viruses, bacteria and fungi and that are generally configured to curb the spread of infectious diseases.

### BACKGROUND

In a highly diverse and mobile population, infectious diseases can spread with the greatest of ease. The 2020 COVID19 pandemic is but the latest viral disease that has caused widespread disruption to commerce. The regulated gaming industry is not exempt and was severely impacted by the COVID19 pandemic, as casinos around the world closed in an effort to contain the spread of the virus. What are needed, therefore, are gaming machines and associated methods that are designed to resist viruses and bacteria and that are generally configured to curb the spread of infectious diseases and associated methods.

### BRIEF DESCRIPTION OF THE DRAWINGS

FIG. 1 shows an electronic gaming machine and a block diagram of a computing device therein, according to an embodiment.

FIG. 2 shows another electronic gaming machine cabinet, constructed according to an embodiment.

FIG. 3 shows a bar and a bar-top version of an electronic game cabinet, constructed according to one embodiment.

FIG. 4 shows two electronic gaming cabinets according to embodiments, and a digital spacer therebetween, also configured according to an embodiment.

### DETAILED DESCRIPTION

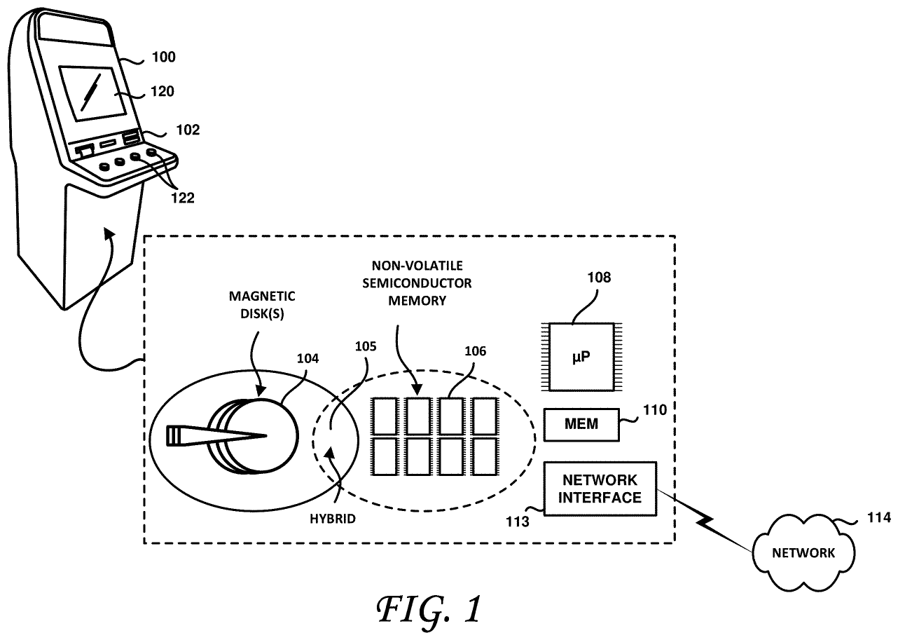

FIG. 1 shows a wager-based regulated gaming machine (also called an electronic gaming machine or EGD) configured according to embodiment. According to one embodiment, an electronic, wager-based gaming device 102 may comprise cabinet 100, a memory 104, 105, 106, 110, at least one processor 108, one or more displays 120 and various user interfaces 122. The gaming machine 102, which may also be implemented as a home gaming console or a portable computing device, may comprise direct access data storage devices such as magnetic disks 104, non-volatile semiconductor memories (EEPROM, Flash, etc.) 106, a hybrid data storage device 105 comprising both magnetic disks 104 and non-volatile semiconductor memories, one or more microprocessors 108 and volatile memory 110. The regulated gaming machine 102 may also comprise a network interface 113, configured to communicate over network 114 with remote servers, storage services and the like. References 104, 105 and 106 are examples of tangible, non-transitory computer-readable media having data stored thereon representing sequences of instructions or processing logic which, when executed by a regulated gaming computing device, cause the regulated gaming computing device to enable the gaming device to provide games and process wagers. Some of these instructions may be stored locally in the gaming machine 102, while others of these instructions may be stored (and/or executed) remotely and communicated to the gaming machine 102 over the network 114. In other embodiments, all these instructions may be stored locally in the gaming machine 102, while in still other embodiments, all of these instructions are stored and executed remotely, based on payer interactions at the gaming machine 102, and the results communicated to the gaming machine 102. In another embodiment, the instructions may be stored on another form of a tangible, non-transitory computer readable medium.

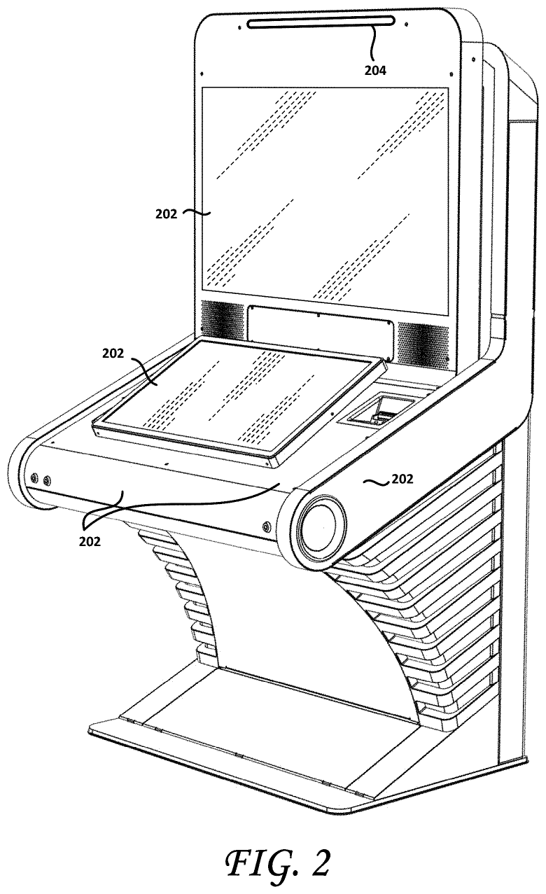

In one embodiment, the gaming machine may comprise a cabinet that includes and/or is formed of a material that exhibits antiviral, antimicrobial and/or antifungal characteristics and/or a material that is inhospitable to virus and potentially harmful microbes. In one embodiment shown in FIG. 2, the surfaces 202 designed to be touched and manipulated by the human players may be configured to kill virus, bacteria and fungi or at least shorten their survivability outside of their human host. Such surfaces 202 may include the player interface such as, for example, buttons, levers, weapons, triggers, trackballs, touchscreens, ancillary equipment for game function and/or any other surface designed for physical interaction with the player. Other surfaces, exterior of the gaming cabinet may also be manufactured to also exhibit such antiviral, antimicrobial and/or antifungal characteristics. This includes, but is not limited to, plastic surfaces with which the player interacts, which may be injection-molded or extruded from thermoplastic polymer pellets, powders or liquids. These plastic pellets, powders or liquids may be formed of or include, for example, polypropylene which is a widely-used thermoplastic polymer, polyoxymethylene (POM), a dimensionally stable thermoplastic with high stiffness and low friction and/or polycarbonate, another widely-used thermoplastic material with good temperature resistance and impact strength. Such materials may be configured, according to embodiments, to significantly decrease virus and microbial count , particularly when applied in parent materials, such as, powder coat, paint, adhesive films, plastics, polymers, textiles and fabrics.

According to one embodiment, one or more materials that promote the above-mentioned antiviral, antimicrobial and/or antifungal characteristics may be added to the injection molding material at the time when the EGM parts are manufactured, such that the material itself becomes inhospitable to such microbes, viruses or fungi. In contrast to some coatings or films placed over the high-touch areas of the EGD, cleaning the gaming machine will have little effect upon the desired properties, as such are incorporated directly into the very material (in one embodiment, at least the top layer thereof) forming these high-touch structures, and cannot be wiped off, or rendered ineffective by common household or industrial cleaning agents.

In one embodiment, particles having antiviral, antimicrobial and/or antifungal characteristics may be added to the injection-molded or extrusion material. The amount of such added antiviral, antimicrobial and/or antifungal particles may be dependent upon the precise polymer used, the tensile and impact resistant strength desired and/or any other parameter. In one embodiment, silver (Ag) particles (and/or oxides thereof) may be added to the polymer pellets to be injection molded. In another embodiment, copper (Cu) particles (and/or oxides) may be used alone or in tandem with the silver particles. Both silver and copper are inorganic antimicrobial agents and are particularly well-suited to shorten the survivability of viruses deposited thereon. Other materials may be used such as, for example, Calcium (Ca), Aluminum (Al), Zinc (Zn), Nickel (Ni) or Tungsten (W). In one embodiment, one or more of these materials may be added to selected injection-molded parts of the EGD as superfine nanoparticles of, for example, 1000 nm or smaller.

Therefore, parts of an EGM that are designed to physically interact with the player may include such antiviral, antimicrobial and/or antifungal materials and other parts thereof need not contain or be formed of such materials. Polymers suitable for being formed into high-touch areas of an EGM may be manufactured by preparing a mixture of a polymeric material and a powder of copper oxides (for example) and extruding or molding the mixture into the desired shape to form a polymeric material having antiviral, antimicrobial and/or antifungal properties. Some of the oxide particles may at the surface of the material, while the remainder may be embedded more deeply in the bulk material. In any event, at least some of the added antiviral, antimicrobial and/or antifungal particles added to the polymer, residing on the surface of the manufactured part (which may be confirmed by electron microscopy), will come into contact with the player and resist or kill or otherwise inactivate at least some of the microbes, viruses or fungi that may be or have been shed thereon by the player. Other treatments and/or manufacturing processes compatible with embodiments include powder coating, reaction injection molding, cross-linked coatings, rotational molding, and foaming processes. Such additives are compatible with a number of plastics that may form part of the cabinet including, for example, Acrylonitrile Butadiene Styrene (ABS), Polypropylene (PP), Polystyrene (PS), high and low density Polyethylene (HDPE/LDPE), Polyvinyl chloride (PVC) and Polycarbonate (PC).

In other embodiments, not only does the material itself exhibit anti-microbial, anti-viral or anti-fungal characteristics, but the surface texture thereof may be made to be hydrophobic, so as best to repel water in the form of moisture, sweat or other potentially contaminated bodily fluids and resist the formation of biofilms in high-touch user interface areas. Biofilms comprise any syntrophic consortium of microorganisms in which cells stick to each other and often also to a surface. These adhered cells become embedded within a thin matrix composed of extracellular polymeric substances (EPS). The cells within the biofilm produce the EPS components, which are typically a polymeric conglomeration of extracellular polysaccharides, proteins, lipids and DNA. Biofilms may form on living or non-living surfaces and can be prevalent in natural, industrial, and hospital settings or, most significantly here, on exposed surfaces of electronic gaming machines and in other high traffic areas of casinos. Biofilms have been found to contribute to a wide variety of microbial infection.

To further resist the formation of biofilms, portions of the gaming cabinet material may be made to be extremely smooth, down to the nano-level, or may expressly be formed to include crevices or fine scales that trap air, which air-trapping crevices act as a superhydrophobic surface. In another embodiment, the gaming cabinet or parts thereof may be “wrapped” in an hydrophobic film, which may be periodically replaced. According to one embodiment, displays such as touch screens may be provided with such a hydrophobic film, which may be periodically and easily replaced to provide continuing and cost-effective viral, fungal and microbial mitigation. The inclusion of such antimicrobial, antifungal or antiviral additives may be carried out without substantially affecting the look and feel of the gaming cabinet and may be configured to retain the original surface texture, color, durability and resistance to industrial cleaners.

Other methods of providing biofilm resistance and generally, anti-viral, anti-microbial and anti-fungal activities on surfaces of casino gaming machines may be used, according to further embodiments. For example, the surface charge of polymers used in the construction of gaming cabinets may be manipulated to resist biofilm formation and adherence. Based on electrostatic principles, charged particles will repel other particles of like charge. The hydrophobicity and the charge of the long polymeric chains of gaming cabinet plastics may be controlled by using several backbone compounds and antimicrobial agents. Positively charged polycationic chains enables the molecule to stretch out and generate bactericidal activity. In another embodiment, low-energy waves may be generated against gaming cabinet (perhaps when no player is currently playing a game), to deliver low energy, high frequency vibrations using a piezoelectric transducer, according to one embodiment. For example, periodic (e.g., rectangular or triangular) pulses may be generated through an actuator using a piezoelectric plate attached to selected portions of the gaming cabinet. The thus-generated waves traverse the thickness of the gaming cabinet to reach to the high-touch surfaces thereof and create horizontal energetic waves that prevent or hamper the adhesion of bacteria and biofilms thereon.

Other embodiments include, as shown in FIG. 2, a bactericide or viricide-dispensing spray or mist outlet. In such an embodiment, a light spray or mist having anti-bacterial, anti-viral and/or anti-fungal properties may be sprayed from an internal reservoir within the gaming cabinet or stored externally thereto out through an outlet 204 to disinfect the underlying exposed surfaces of the gaming cabinet. Such may occur between players or during periods when players are least likely to approach the electronic gaming machine. The spray or mist may be incorporated into a safe volatile liquid such as isopropyl alcohol, for example. In this manner, the spray evaporates shortly after coming into contact with the surface of the gaming cabinet, leaving little or no residue thereon. In a similar manner, ultra-violet light sources may be incorporated into the gaming cabinet to periodically illuminate the surface of the cabinet, to further resist the formation and survivability of potentially harmful bacteria, microbes and fungi. Other high-touch surfaces may include copper, a known bacteria and virus inhibitor.

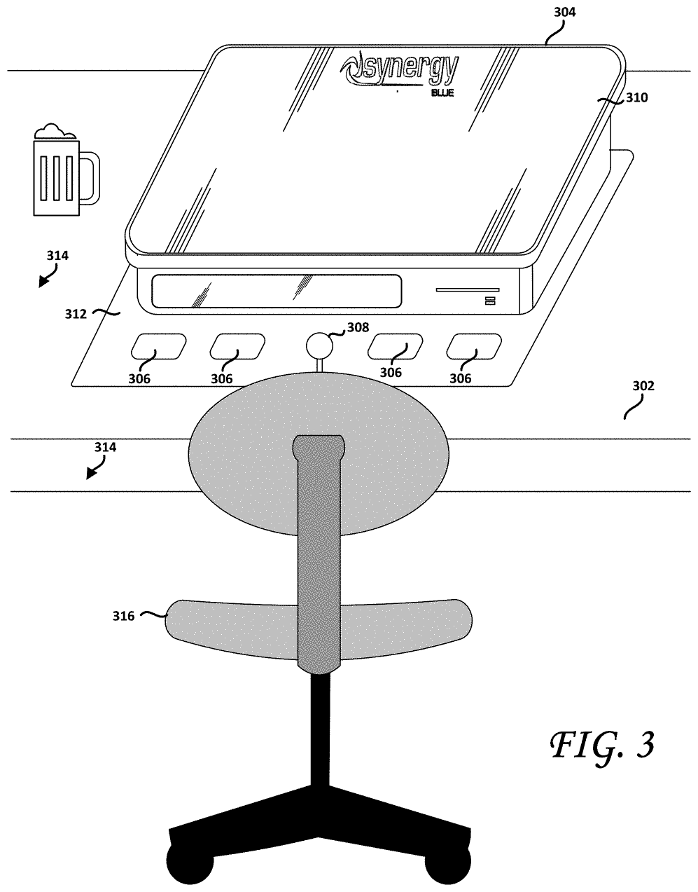

FIG. 3 shows a bar 302 and a bar-top version 304 of an electronic game cabinet, constructed according to one embodiment. According to one embodiment, the bar top EGM may also be constructed to include materials having antiviral, antimicrobial and antifungal properties, on some or all surfaces with which the player may interact. For example, the buttons 306 and trackball 308 may include or be formed of such materials. Alternatively, a thin, flexible and plastic film having such antiviral, antimicrobial and antifungal properties may be disposed over these surfaces. The touch screen 310, for example, may be covered in such a thin film, which may be easily cleaned and/or periodically replaced. Alternatively, the glass or polycarbonate of the display itself may be so treated, as may be the base of the EGM, as shown at reference number 312.

At the time of installation of the bar top EGM, the surface of the bar itself may be treated, as described and shown herein, to include similar antiviral, antimicrobial and antifungal properties. Alternatively still, the entire bar top may be replaced with a similar bar surface comprising such antiviral, antimicrobial and antifungal properties, as may the barstools 316. Indeed, the fabric portions of the stool may be treated to include polymeric biocide agents at the surface, or incorporated into the fibers, providing the barstool with anti-microbial, antifungal or viricidal properties. In this manner, the bar surface, the barstool and the bar top electronic gaming machine may be manufactured or treated to kill or inhibit the survivability of a number of common pathogens such as, for example, E. coli, methicillin-resistant Staphylococcus aureus (MRSA), Staphylococcus, Clostridium difficile, influenza A virus, adenovirus, and fungi.

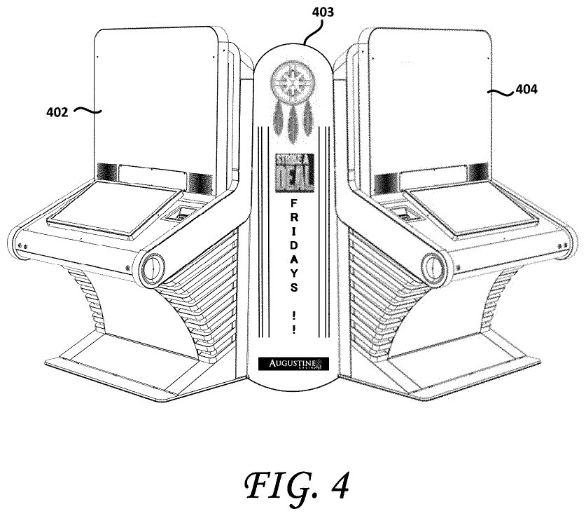

FIG. 4 shows two electronic gaming cabinets 402, 404 according to embodiments, and a digital spacer 403 therebetween, also configured according to an embodiment. A digital spacer is any kind of static or video display surface between two or more electronic gaming machines. As such a surface is likely to be touched by players, it too may be treated to include such viricidal, biocidal and fungicidal properties. Such antiviral, antimicrobial and antifungal additives may be incorporated into to display surfaces of the digital spacer or incorporated into thin films stretched over the display surfaces.

Other applications may be envisaged with ease. For example, poker chips may be formed of impact resistant plastic material comprising such antiviral, antimicrobial and antifungal properties, as may player cards. The felt fabric under on blackjack tables may incorporate fibers having such antiviral, antimicrobial and antifungal properties. Other applications will occur to those of skill in this art.

Accordingly, one embodiment is a gaming machine, comprising a cabinet; at least one processor disposed within the cabinet; memory disposed within the cabinet; a communication interface disposed within the cabinet; at least one player interface supported by the cabinet, the at least one player interface comprising at least one display, wherein the at least one player interface and at least a portion of the gaming cabinet at least one of: includes a first material that exhibits at least one of antiviral, antimicrobial and antifungal characteristics, and is covered by a second material that is inhospitable to at least one of viruses, microbes and fungi.

According to further embodiments, at least some surfaces of the player interface(s) and/or the gaming cabinet that are designed to be touched and manipulated by players are configured to kill virus, bacteria and fungi or at least shorten a survivability of the virus, bacteria and fungi. The first material and/or the second material may be an injection molding or extrusion material to which particles having antiviral, antimicrobial and/or antifungal characteristics are added. The added particles may include, for example, silver, copper, calcium, aluminum, zinc, nickel and/or tungsten and/or their oxides. In one embodiment, the added particles are no larger than 1000 nm in size. At least some of the added particles may be disposed at or near a player-accessible surface and the remainder of the added particles may be embedded or incorporated within the bulk material of the player interface(s) and/or the gaming cabinet. In one embodiment, the surface charge of polymers in the first material and/or the second material is configured, manipulated or otherwise changed so as to resist biofilm formation and adherence and so as to exhibit antimicrobial and antibacterial activity. A coating or film that is configured to exhibit antiviral, antimicrobial and/or antifungal characteristics may be disposed on at least a portion of the gaming cabinet and/or at least a portion of the player interface(s). At least a portion of a surface of the gaming cabinet and/or surfaces of the player interface(s) may be configured to resist the formation of biofilms thereon. In another embodiment, at least a portion of a surface of the gaming cabinet and/or surfaces of the player interface(s) may be configured to be hydrophobic. In yet another embodiment, at least a portion of a surface of the gaming cabinet and surfaces of the player interface(s) may be configured to be sufficiently smooth as to inhibit growth or survival of viruses, microbes or fungi thereon. At least a portion of a surface of the gaming cabinet and/or surfaces of the player interface(s) may be configured to comprise air-trapping crevices (such as scales, for example) so as to be superhydrophobic. In still another embodiment, a periodically-replaceable hydrophobic film may be disposed over at least a portion of a surface of the gaming cabinet and surfaces of the player interface(s). One or more actuators may be provided to selectively generate vibrations and to impart the generated vibrations to the player interface(s) and/or at least a portion of a surface of the gaming cabinet—such as when the gaming machine is not in use, to inhibit formation, growth or survivability of viruses, microbes and/or fungi on the cabinet and/or the player interface(s). A reservoir may be disposed within the gaming machine and the solution may be sprayed or misted from an outlet. The solution may have anti-bacterial, anti-viral and/or anti-fungal properties. A source of ultra-violet light may be provided to periodically illuminate (e.g., when the gaming machine is not in use) at least some exposed surfaces of the gaming machine with ultra-violet light.

Another embodiment is an assembly, comprising: a first gaming machine; a second gaming machine, and a digital spacer disposed between and coupled to the first and the second gaming machine, wherein the digital spacer at least one of: includes a first material that exhibits at least one of antiviral, antimicrobial and antifungal characteristics, and is covered by a second material that is inhospitable to at least one of viruses, microbes and fungi.

While certain embodiments of the disclosure have been described, these embodiments have been presented by way of example only, and are not intended to limit the scope of the disclosure. Indeed, the novel methods, devices and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure.

1. A gaming machine, comprising:
a cabinet;
at least one processor disposed within the cabinet;
memory coupled to the at least one processor and disposed within the cabinet;
a communication interface coupled to the at least one processor and disposed within the cabinet;
at least one player interface supported by the cabinet, the at least one player interface comprising at least one display,
wherein the at least one player interface and at least a portion of the gaming cabinet at least one of:
includes a first material that exhibits at least one of antiviral, antimicrobial and antifungal characteristics, and
is covered by a second material that is inhospitable to at least one of viruses, microbes and fungi.

2. The gaming machine of claim 1, wherein at least some surfaces of the at least one player interface and the gaming cabinet that are designed to be touched and manipulated by players are configured to kill virus, bacteria and fungi or at least shorten a survivability of the virus, bacteria and fungi outside of the human players.

3. The gaming machine of claim 1, wherein at least one of the first material and the second material is an injection molding or extrusion material to which particles having antiviral, antimicrobial and/or antifungal characteristics are added.

4. The gaming machine of claim 3, wherein the added particles include at least one of silver, copper, calcium, aluminum, zinc, nickel and tungsten and/or their oxides.

5. The gaming machine of claim 3, wherein the added particles are no larger than 1000 nm in size.

6. The gaming machine of claim 3, wherein at least some of the added particles are disposed at or near a player-accessible surface and wherein a remainder of the added particles are be embedded within a bulk material of the at least one player interface and the gaming cabinet.

7. The gaming machine of claim 1, wherein a surface charge of polymers in at least one of the first material and the second material is configured so as to resist biofilm formation and adherence and so as to exhibit antimicrobial and antibacterial activity.

8. The gaming machine of claim 1, further including a coating or film that is configured to exhibit antiviral, antimicrobial and/or antifungal characteristics, the coating or film being disposed on at least a portion of the gaming cabinet or at least a portion of the at least one player interface.

9. The gaming machine of claim 1, wherein at least a portion of a surface of the gaming cabinet and surfaces of the at least one player interface are configured to resist formation of biofilms thereon.

10. The gaming machine of claim 1, wherein at least a portion of a surface of the gaming cabinet and surfaces of the at least one player interface is configured to be hydrophobic.

11. The gaming machine of claim 1, wherein at least a portion of a surface of the gaming cabinet and surfaces of the at least one player interface are configured to be sufficiently smooth to inhibit growth or survival of viruses, microbes or fungi thereon.

12. The gaming machine of claim 1, wherein at least a portion of a surface of the gaming cabinet and surfaces of the at least one player interface is configured to comprise air-trapping crevices so as to be superhydrophobic.

13. The gaming machine of claim 1, further comprising a periodically-replaceable hydrophobic film over at least a portion of a surface of the gaming cabinet and surfaces of the at least one player interface.

14. The gaming machine of claim 1, further comprising at least one actuator configured to selectively generate vibrations and to impart the generated vibrations to at least one of the at least one player interface and at least a portion of a surface of the gaming cabinet.

15. The gaming machine of claim 1, further comprising a reservoir disposed within the gaming machine and a spray or mist outlet that is configured to spray or mist a solution from the reservoir, the solution having at least one of an anti-bacterial, anti-viral and anti-fungal property onto at least some exposed surfaces of the gaming machine.

16. The gaming machine of claim 1, further comprising a source of ultra-violet light that is configured to periodically illuminate at least some exposed surfaces of the gaming machine with ultra-violet light.

17. An assembly, comprising:
a first gaming machine;
a second gaming machine, and
a digital spacer disposed between and coupled to the first and the second gaming machine,
wherein the digital spacer at least one of:
includes a first material that exhibits at least one of antiviral, antimicrobial and antifungal characteristics, and
is covered by a second material that is inhospitable to at least one of viruses, microbes and fungi.
